(19) United States
(12) Patent Application Publication
(10) Pub. No.: US 2015/0131748 A1
(43) Pub. Date: May 14, 2015

(54) ENCODING DEVICE AND ENCODING METHOD

(71) Applicant: Kabushiki Kaisha Toshiba, Minato-ku (JP)

(72) Inventors: Toshiyuki ONO, Kawasaki (JP); Takuya Matsuo, Fuchu (JP); Akiyuki Tanizawa, Kawasaki (JP); Tomoya Kodama, Kawasaki (JP)

(73) Assignee: Kabushiki Kaisha Toshiba, Minato-ku (JP)

(21) Appl. No.: 14/505,644

(22) Filed: Oct. 3, 2014

(30) Foreign Application Priority Data
Nov. 12, 2013 (JP) 2013-234243

(51) Int. Cl. H04N 19/85; H04N 19/136

(52) U.S. Cl. CPC H04N 19/85; H04N 19/136
USPC 375/240.29; 375/240.08

(57) ABSTRACT

According to an embodiment, an encoding device includes a processor and a memory. The processor applies a filter to first and second images included in moving image (video) data. The processor encodes the first and second images to which the filter has been applied and generates encoded data. The processor generates, on the basis of an encoding completion target time of the first image included in the moving image data, a target value of an encoding time spent for encoding the second image to be encoded after the first image. The processor controls the applying of the filter for the second image depending on the target value of the encoding time.

### CROSS-REFERENCE TO RELATED APPLICATION

This application is based upon and claims the benefit of priority from Japanese Patent Application No. 2013-234243, filed on Nov. 12, 2013; the entire contents of which are incorporated herein by reference.

### FIELD

Embodiments described herein relate generally to an encoding device and an encoding method.

### BACKGROUND

Conventionally, as preprocessing in encoding of a moving image (video), there has been a technique for adjusting low frequency components and high frequency components included in the image. By reducing high frequency components of an image, it is possible to reduce the amount of code. Therefore, by performing such preprocessing, it is possible to adjust the bit rate of encoded data to be output.

In an encoding device which is configured by hardware, design is made corresponding to a case that requires the largest amount of calculation. Therefore, encoding time of each frame or each scene can be made constant. However, when encoding a moving image by a software program, variation occurs in the encoding time of each frame or each scene. Therefore, for example, depending on the ability of a processor that executes the software program, an encoding method, the size of moving image data, and the like, the execution of encoding in real time may be difficult even when the bit rate is adjusted by performing preprocessing.

### BRIEF DESCRIPTION OF THE DRAWINGS

FIG. 1 is a diagram illustrating an encoding device according to a first embodiment;

FIG. 2 is a flow chart illustrating processing performed by the encoding device according to the first embodiment;

FIG. 3 is a flow chart of control signal generation processing;

FIG. 4 is a diagram for explaining a method for calculating a target value of an encoding time;

FIG. 5 is a diagram for explaining a case where an excess is recovered in two frames;

FIG. 6 is a diagram for explaining a case where encoding is started at a target time;

FIG. 7 is a diagram for explaining a case where encoding is started at a completion time;

FIG. 8 is a diagram illustrating an example of a control signal;

FIG. 9 is a diagram illustrating an example of the configuration of a processor;

FIG. 10 is a diagram illustrating an example of the prediction structure of encoding;

FIG. 11 is a diagram illustrating an encoding device according to a second embodiment;

FIG. 12 is a flow chart illustrating processing performed by the encoding device according to the second embodiment;

FIG. 13 is a diagram illustrating an encoding device according to a third embodiment;

FIG. 14 is a flow chart illustrating the flow of processing performed by the encoding device according to the third embodiment;

FIG. 15 is a flow chart illustrating the flow of processing performed by a control unit according to the third embodiment; and

FIG. 16 is a diagram illustrating the hardware of an encoding device according to an embodiment.

### DETAILED DESCRIPTION

According to an embodiment, an encoding device includes a processor and a memory. The processor applies a filter to first and second images included in moving image (video) data. The processor encodes the first and second images to which the filter has been applied and generates encoded data. The processor generates, on the basis of an encoding completion target time of the first image included in the moving image data, a target value of an encoding time spent for encoding the second image to be encoded after the first image. The processor controls the applying of the filter for the second image depending on the target value of the encoding time.

Hereinbelow, an encoding device of an embodiment will be specifically described with reference to the drawings. In the following embodiments, components denoted by the same reference numerals operate in the same manner, and overlapping descriptions excepting different points will be appropriately omitted.

### First Embodiment

An encoding device of the present embodiment aims at encoding moving image (video) data at a speed that is equal to the reproduction speed or higher than the reproduction speed. Specifically, control is performed so that the reproduction time of data of a moving image or the like is not exceeded by the time required for encoding the data.

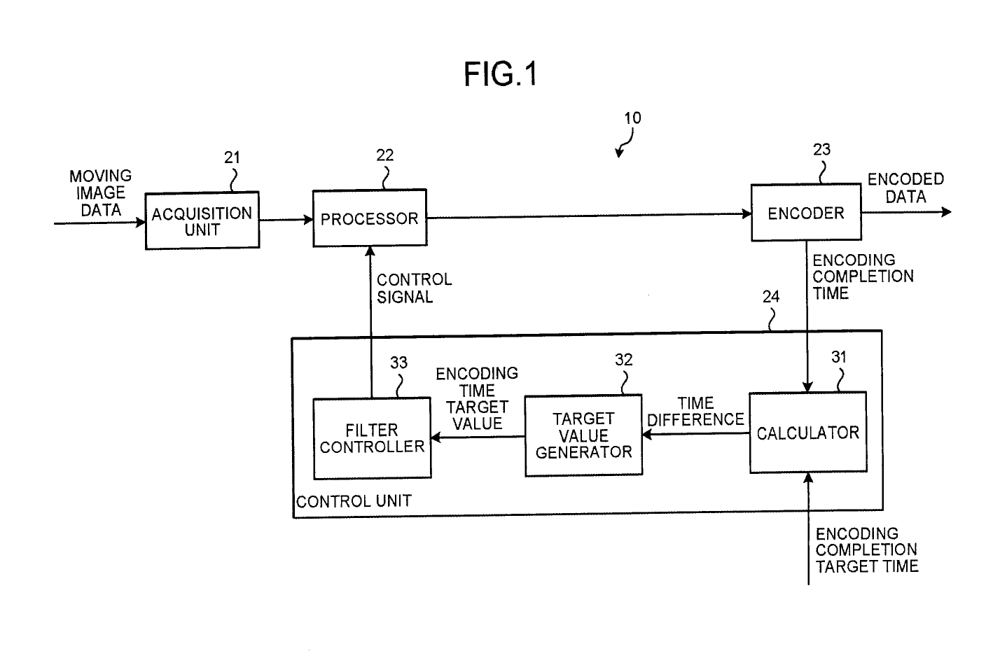

FIG. 1 is a block diagram of the encoding device 10 according to the first embodiment. The encoding device 10 encodes moving image data by a predetermined method to generate encoded data. The encoding device 10 is provided with an acquisition unit 21, a processor 22, an encoder 23, and a control unit 24.

The acquisition unit 21 receives moving image data having a predetermined frame rate, for example, from an imaging apparatus, a storage medium reproduction apparatus, or a broadcast signal receiver. The acquisition unit 21 sequentially acquires a plurality of images included in the received moving image data. As an example, the acquisition unit 21 sequentially acquires a plurality of frames from the moving image data. Alternatively, the acquisition unit 21 may acquire images in the unit of field from interlaced moving image data. The acquisition unit 21 sequentially supplies the acquired images to the processor 22.

The processor 22 applies a filter to each of the images acquired by the acquisition unit 21. As an example, the processor 22 applies a filter that reduces the information amount of an image to each of the images. The information amount refers to the complexity of an image, the amount of patterns included in an image, the entropy of an image, the energy of high frequency components of an image, and the like. As an example, the processor 22 uses a low pass filter as the filter that reduces the information amount. Further, the processor 22 may use a noise removal filter as the filter that reduces the information amount.

Further, the processor 22 may apply a filter that increases the information amount to a plurality of images. As an example, the processor 22 uses a high frequency emphasis filter as the filter that increases the information amount. Further, the processor 22 may filter the images by switching the filter that reduces the information amount and the filter that increases the information amount. In this case, the processor 22 may switch the filter that reduces the information amount and the filter that increases the information amount depending on time. Further, the processor 22 sequentially supplies the filter-processed images to the encoder 23.

The encoder 23 encodes moving image data that contains a plurality of filter-processed images by a predetermined method to generate encoded data. More specifically, the encoder 23 encodes moving image data by a method performing intra-frame/inter-frame prediction processing of a moving image, quantization processing of a prediction residual in a frequency region, and entropy encoding of the quantized prediction residual. As an example, the encoder 23 encodes moving image data by a method standardized by moving picture experts group (MPEG)-1, MPEG-2, MPEG-4, H.264/AVC, H.265/HEVC, or the like to thereby generate encoded data.

The encoder 23 outputs the generated encoded data, for example, to a multiplexing unit in the following stage. The multiplexing unit, for example, multiplexes encoded data generated by the encoder 23 together with another encoded data and voice data. Further, the multiplexing unit records the multiplexed data on a recording medium or outputs the multiplexed data to a transfer medium.

The control unit 24 controls, on the basis of an encoding completion target time of a first image included in moving image data and an encoding completion time of the first image included in the moving image data, filter processing performed by the processor 22 for a second image which is encoded after the first image. More specifically, the control unit 24 includes a calculator 31, a target value generator 32, and a filter controller 33.

The calculator 31 acquires the encoding completion time of each of the images (first images) encoded by the encoder 23. Further, the calculator 31 acquires an encoding completion target time of each of the images (first images) encoded by the encoder 23.

As an example, the calculator 31 acquires the encoding completion target time of each of the images from the encoder 23. Further, the encoding completion target time of each of the images is fixed by determining the frame rate of the moving image data and the encoding completion target time of a head image in the moving image data. Therefore, the calculator 31 may acquire the encoding completion target time of the head image, for example, from the encoder 23, and calculate the encoding completion target time of each of the other images on the basis of the frame rate and the encoding completion target time of the head image by an arithmetic operation.

Then, the calculator 31 calculates the time difference between the encoding completion time and the target time for each of the images encoded by the encoder 23. The calculator 31 supplies the calculated time difference to the target value generator 32.

The target value generator 32 generates, on the basis of the time difference between the encoding completion time of the first image and the encoding completion target time of the first image, a target value of an encoding time spent for encoding a second image that is encoded after the first image. The second image is not limited to an image that is encoded following the first image as long as it is encoded after the first image.

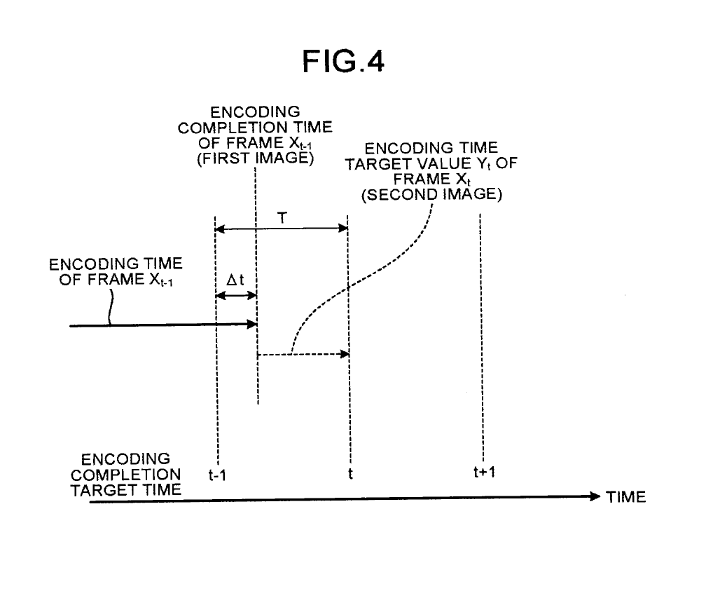

As an example, the target value generator 32 makes the target value of the encoding time spent for encoding the second image shorter as the encoding completion time of the first image becomes further later than the target time. Further, as an example, the target value generator 32 makes the target value of the encoding time spent for encoding the second image longer as the encoding completion time of the first image becomes further earlier than the target time. A concrete example of a method for generating the encoding time target value by the target value generator 32 will be described below with reference to FIGS. 4 to 7.

The filter controller 33 controls filter processing for the second image depending on the encoding time target value generated by the target value generator 32. As an example, the filter controller 33 supplies a control signal to the processor 22 to control the filter processing for the second image encoded after the first image by the processor 22.

For example, when the processor 22 uses the filter that reduces the information amount, the filter controller 33 performs the control so as to make the amount of information reduced by the filter larger as the encoding time target value is smaller and make the amount of information reduced by the filter smaller as the encoding time target value is larger. On the other hand, when the processor 22 uses the filter that increases the information amount, the filter controller 33 performs the control so as to make the amount of information increased by the filter larger as the encoding time target value is larger and make the amount of information increased by the filter smaller as the encoding time target value is smaller. A concrete example of a method for controlling the processor 22 by the filter controller 33 will be described below with reference to FIG. 8.

The control unit 24 having such a configuration makes it possible to control the filter processing performed by the processor 22 so as to reduce the information amount of the second image which is encoded after the first image when the encoding completion time of the first image encoded by the encoder 23 is later than the target time. For example, when the processor 22 uses a filter that reduces the information amount, the control unit 24 can perform the control so as to make the information reduction amount larger when the encoding completion time of the first image is later than the target time. Further, for example, when the processor 22 uses the filter that increases the information amount, the control unit 24 can perform the control so as to make the information increasing amount smaller when the encoding completion time of the first image is later than the target time.

Further, the control unit 24 controls the filter processing performed by the processor 22 so as to increase the information amount of the second image which is encoded after the first image when the encoding completion time of the image encoded by the encoder 23 is earlier than the target time. For example, when the processor 22 uses a filter that reduces the information amount, the control unit 24 performs the control so as to make the information reduction amount smaller when the encoding completion time of the first image is earlier than the target time. Further, for example, when the processor 22 uses the filter that increases the information amount, the control unit 24 performs the control so as to make the information increasing amount larger when the encoding completion time of the first image is earlier than the target time.

The encoder 23 performs intra-frame/inter-frame prediction processing of a moving image, quantization processing of a prediction residual in a frequency region, and entropy encoding processing of the quantized prediction residual. Therefore, the encoder 23 can further improve the prediction accuracy of the encoder 23 to thereby reduce the prediction residual when an image has a smaller amount of information. As a result, in the encoder 23, the encoding time becomes shorter when an image has a smaller amount of information. On the other hand, in an image having a larger amount of information with respect to the encoder 23, the prediction accuracy of the encoder 23 is deteriorated and the prediction residual is thereby increased. As a result, in the encoder 23, the encoding time becomes longer when an image has a larger amount of information.

Therefore, when the encoding time of a past image is longer than the target, the control unit 24 can make the encoding time of a subsequent image shorter. Further, when the encoding time of a past image is shorter than the target, the control unit 24 can make the encoding time of a subsequent image longer. Accordingly, the encoding device 10 makes it possible to reduce variation in the encoding time of each image included in moving image data.

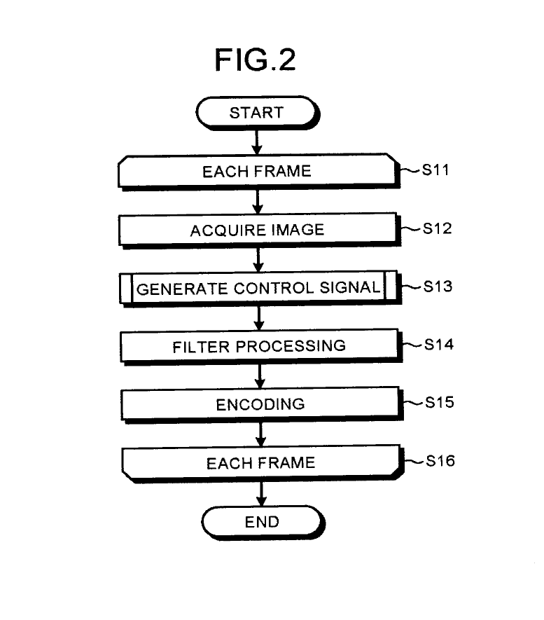

FIG. 2 is a flow chart illustrating the flow of processing performed by the encoding device 10 according to the first embodiment. When the input of moving image data is started, the encoding device 10 repeatedly performs processing from S12 to S15 for each frame (or each field) included in the moving image data (loop processing between S11 and S16).

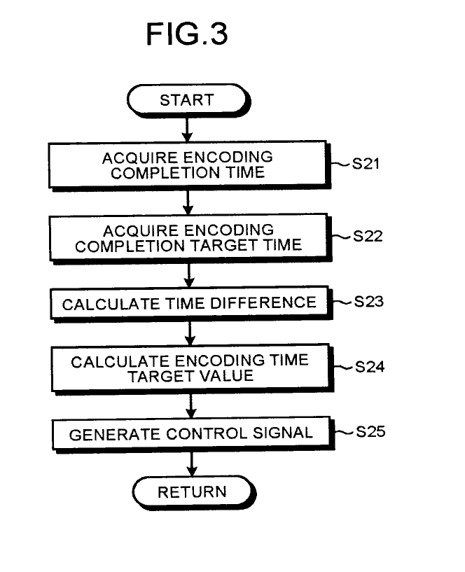

In the loop processing, the acquisition unit 21 first acquires an image (second image) in the unit of frame (or in the unit of field) in S12. Then, in S13, the control unit 24 generates a control signal for controlling the information reduction amount or the information increasing amount on the basis of the encoding completion time of an image (first image) encoded prior to the second image and the encoding completion target time of the image (first image). A procedure for generating the control signal will be described below with reference to the flow of FIG. 3.

Then, in S14, the processor 22 performs filter processing on the image (second image) acquired by the acquisition unit 21 under the control by the control signal. Then, in S15, the encoder 23 encodes the image (second image) filter-processed by the processor 22.

The encoding device 10 repeatedly performs the above processing from S12 to S15 while moving image data is being input. When the input of moving image data is stopped, the encoding device 10 finishes the processing of this flow.

FIG. 3 is a flow chart illustrating the processing of S13 of FIG. 2. In S13, the control unit 24 performs processing from S21 to S25 of FIG. 3.

First, in S21, the control unit 24 acquires the encoding completion time of an image (first image) encoded in the past. Then, in S22, the control unit 24 acquires the encoding completion target time of the image (first image) encoded in the past. Then, in S23, the control unit 24 calculates the time difference between the encoding completion time and the target time of the image (first image) encoded in the past.

Then, in S24, the control unit 24 calculates a target value of the encoding time spent for encoding an image (second image) acquired by the acquisition unit 21. A method for calculating the encoding time target value will be described below with reference to FIGS. 4 to 7.

Then, in S25, the control unit 24 generates a control signal for controlling the filter processing performed by the processor 22 on the basis of the encoding time target value. A concrete example of the control signal for controlling the filter processing performed by the processor 22 will be described below with reference to FIG. 8. When the processing of S25 is finished, the control unit 24 advances the processing to S14 of FIG. 2.

FIG. 4 is a diagram for explaining a method for calculating the encoding time target value. A frame included in moving image data is denoted by Xₜ (second image) and a frame that is encoded one time before the frame Xₜ is denoted by Xₜ₋₁ (first image). Further, the encoding completion target time of the frame Xₜ is denoted by t and the encoding completion target time of the frame Xₜ₋₁ is denoted by t−1. Further, t and t−1 are fixed by determining an encoding start time of the moving image data and the frame rate of the moving image data. Further, a time interval between the encoding completion target time t−1 of the frame Xₜ₋₁ and the encoding completion target time t of the frame Xₜ is denoted by T.

Here, a case where the time difference between the encoding completion time of the frame Xₜ₋₁ (first image) and the encoding completion target time of the frame Xₜ₋₁ (first image) is Δt is assumed. In this case, as an example, the target value generator 32 calculates a target value Yₜ of the encoding time spent for encoding the frame Xₜ (second image) in accordance with the following Equation (1).

Yₜ=T−Δt (1)

By the target value generator 32 calculating the encoding time target value by such an arithmetic operation, the encoding device 10 can recover an excess amount of the encoding time of the frame Xₜ₋₁ from the target time in the subsequent frame Xₜ.

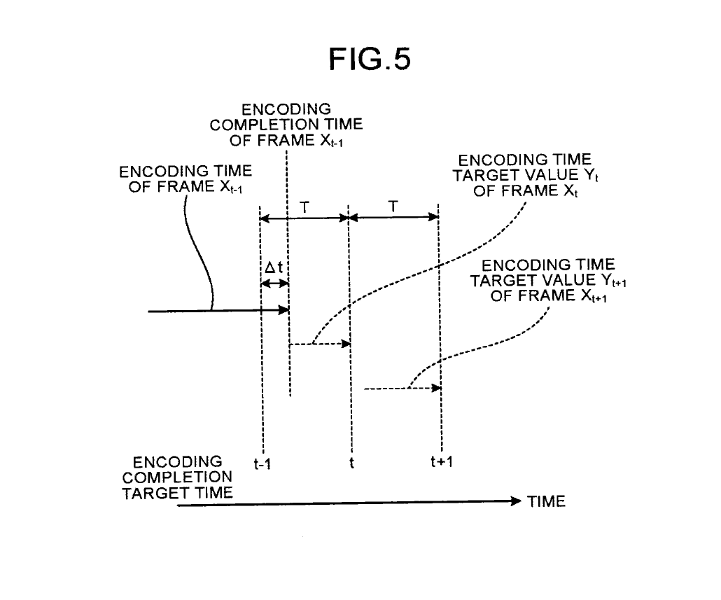

FIG. 5 is a diagram for explaining a method for calculating the encoding time target value for recovering an excess amount of the encoding time in two frames. The frame Xₜ and the frame Xₜ₋₁ are the same as those of FIG. 4. Further, a frame that is encoded one time after the frame Xₜ is denoted by Xₜ₊₁. Further, the encoding completion target time of the frame Xₜ₊₁ is denoted by t+1. Further, a time interval between the encoding completion target time t of the frame Xₜ and the encoding completion target time t+1 of the frame Xₜ₊₁ is denoted by T.

Here, a case where the time difference between the encoding completion time of the frame Xₜ₋₁. (first image) and the encoding completion target time of the frame Xₜ₋₁ (first image) is Δt is assumed. In this case, as an example, the target value generator 32 calculates a target value Yₜ of the encoding time spent for encoding the frame Xₜ and a target value Yₜ₊₁ of the encoding time spent for encoding the frame Xₜ₊₁ in accordance with the following Equation (2).

Yₜ=Yₜ₊₁={(2×T)−Δt}/2 (2)

By the target value generator 32 calculating the encoding time target value by such an arithmetic operation, the encoding device 10 can recover an excess amount of the encoding time of the frame Xₜ₋₁ from the target time in the subsequent two frames Xₜ and Xₜ₊₁.

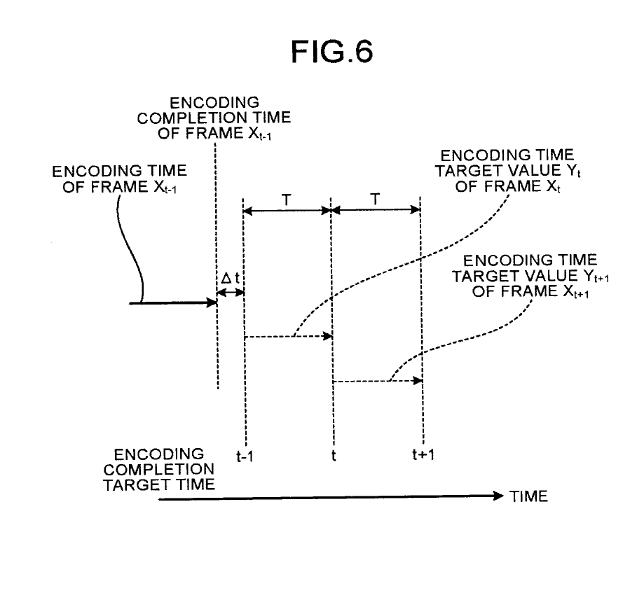

FIG. 6 is a diagram for explaining a method for calculating the encoding time target value when the encoding is started at the encoding completion target time of a preceding frame. The encoding completion time of the frame Xₜ₋₁ may be before the target time. In such a case, the target value generator 32 may set a start point of encoding of the frame Xₜ at the encoding completion target time of the frame Xₜ₋₁ and set a start point of encoding of the frame Xₜ₊₁ at the encoding completion target time of the frame Xₜ.

In this case, the target value generator 32 sets each of the target value Yₜ of the encoding time spent for encoding the frame Xₜ and the target value Yₜ₊₁ of the encoding time spent for encoding the frame Xₜ₊₁ to T as represented by the following Equation (3).

Yₜ=Yₜ₊₁=T (3)

By the target value generator 32 calculating such an encoding time target value, the encoding device 10 can start the encoding of each of the two frames Xₜ and Xₜ₊₁ following the frame Xₜ₋₁ at the encoding completion target time of a frame that is encoded one time before the encoding thereof.

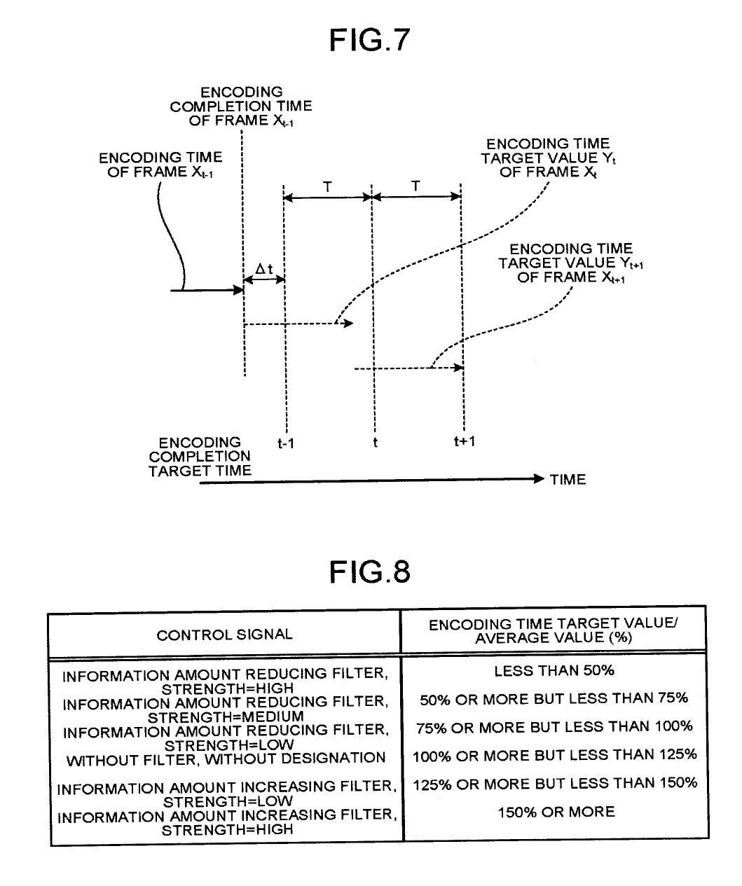

FIG. 7 is a diagram for explaining a method for calculating the encoding time target value when the encoding is started at the encoding completion time of a preceding frame. When the encoding completion time of the frame Xₜ₋₁ is before the target time, the target value generator 32 may set a start point of the encoding of the frame Xₜ at an actual encoding completion time of the frame Xₜ₋₁ and set a start point of the encoding of the frame Xₜ₊₁ at an actual encoding completion time of the frame Xₜ.

In this case, the target value generator 32 calculates each of the target value Yₜ of the encoding time spent for encoding the frame Xₜ and the target value Yₜ₊₁ of the encoding time spent for encoding the frame Xₜ₊₁ in accordance with the following Equation (4).

Yₜ=Yₜ₊₁={(2×T)+Δt}/2 (4)

By the target value generator 32 calculating such an encoding time target value, the encoding device 10 can start the encoding of each of the two frames Xₜ and Xₜ₊₁ following the frame Xₜ₋₁ at the actual encoding completion time of a frame that is encoded one time before the encoding thereof.

FIG. 8 is a diagram illustrating an example of the control signal. As an example, the filter controller 33 switches whether to allow the processor 22 to perform the filter processing or not depending on the encoding target value generated by the target value generator 32.

The filter controller 33 previously calculates an average value of the encoding time per one frame when past moving image data is encoded and holds the calculated average value. Further, the filter controller 33 may encode sample moving image data before operation to thereby previously acquire an average value of the encoding time per one frame.

When the encoding time target value generated by the target value generator 32 is larger than the encoding time average value, the filter controller 33 allows the processor 22 to perform the filter processing using the filter that reduces the information amount. On the other hand, when the encoding time target value generated by the target value generator 32 is equal to or less than the encoding time average value, the filter controller 33 does not allow the processor 22 to perform the filter processing. Accordingly, the filter controller 33 can switch whether to allow the processor 22 to perform the filter processing or not depending on the encoding time target value generated by the target value generator 32.

Further, as an example, the filter controller 33 may switch the contents of the filter processing performed by the processor 22 depending on the encoding time target value generated by the target value generator 32. For example, the filter controller 33 may allow the processor 22 to perform the filter processing using the filter that reduces the information amount when the encoding time target value is larger than the encoding time average value and allow the processor 22 to perform the filter processing using the filter that increases the information amount when the encoding time target value is smaller than the encoding time average value.

Further, the filter controller 33 may switch the strength of a filter depending on the encoding time target value generated by the target value generator 32. As an example, the filter controller 33 switches the strength of the filter that reduces the information amount so as to make the information reduction amount larger as the encoding time target value is further larger than the encoding time average value. Further, as an example, the filter controller 33 switches the strength of the filter that increases the information amount so as to make the information increasing amount larger as the encoding time target value is further smaller than the encoding time average value.

For example, as illustrated in FIG. 8, when the encoding time target value is less than 50% of the encoding time average value, the filter controller 33 selects the filter that reduces the information amount and outputs a control signal that sets the strength of the filter to be high. Further, when the encoding time target value is 50% or more but less than 75% of the encoding time average value, the filter controller 33 selects the filter that reduces the information amount and outputs a control signal that sets the strength of the filter to a middle degree. Further, when the encoding time target value is 75% or more but less than 100% of the encoding time average value, the filter controller 33 selects the filter that reduces the information amount and outputs a control signal that sets the strength of the filter to be low.

Further, as illustrated in FIG. 8, when the encoding time target value is 100% or more but less than 125% of the encoding time average value, the filter controller 33 outputs a control signal that sets the filter processing not to be performed. Further, when the encoding time target value is 125% or more but less than 150% of the encoding time average value, the filter controller 33 selects the filter that increases the information amount and outputs a control signal that sets the strength of the filter to be low. Further, when the encoding time target value is 150% or more of the encoding time average value, the filter controller 33 selects the filter that increases the information amount and outputs a control signal that sets the strength of the filter to be high.

The processor 22 may include only one of the filter that reduces the information amount and the filter that increases the information amount. In this case, the filter controller 33 outputs control signals for setting switching whether to perform the filter processing or not and changing the strength of the filter processing.

The processor 22 can use a low pass filter as the filter that reduces the information amount. In this case, as an example, the processor 22 performs an arithmetic operation for convolution-integrating a Gaussian Kernel with image data as represented by the following Equation (5).

$${I}^{′} ( x , y ) = \frac{1}{N ( x , y )} {\sum }_{( s , t ) ∈ R ( x , y )}^{ } I ( s , t ) exp ( ( - {( s - x )}^{2} - {( t - y )}^{2} ) / 2 {σ}^{2} ) \qquad ( 5 )$$

where I(s, t) denotes a pixel value of a coordinate (s, t) of an image input to the low pass filter. Further, I′(x, y) denotes a pixel value of a coordinate (x, y) of an image output from the low pass filter. Further, σ denotes the standard deviation of a Gaussian Kernel. Further, R(x, y) denotes a set of coordinates within a predetermined Kernel range centering on the coordinate (x, y). Further, N(x, y) is a constant that normalizes the Kernel of the coordinate (x, y), and is specifically represented by the following Equation (6).

$$N ( x , y ) = {\sum }_{( s , t ) ∈ R}^{ } exp ( ( - {( s - x )}^{2} - {( t - y )}^{2} ) / 2 {σ}^{2} ) \qquad ( 6 )$$

When the processor 22 performs the arithmetic operation represented by Equation (5), the filter controller 33 makes σ larger to set the strength high or makes σ smaller to set the strength low by a control signal. As an example, the filter controller 33 sets σ at 2 when setting the strength high, 1.5 when setting the strength to a middle degree, and 1 when setting the strength low.

Further, the processor 22 can use a noise removal filter as the filter that reduces the information amount. The processor 22 can suppress noise components to reduce the information amount of an image while maintaining subjectively important image components such as the edge and texture by using a noise removal filter.

The processor 22 may use, for example, a bilateral filter, a median filter, or a filter that performs processing to which a non-local-means method is applied as the noise removal filter. When the processor 22 uses such a noise removal filter, the filter controller 33 can change the strength by adjusting the kernel size and the smoothing strength of the filter by a control signal.

Further, the processor 22 can use a high frequency emphasis filter as the filter that increases the information amount. When a high-frequency emphasis filter is used, for example, the processor 22 performs an arithmetic operation represented by the following Equation (7).

I″(x,y)=I(x,y)+α(I(x,y)−I′(x,y)) (7)

where I(x, y) and I′(x, y) are the same as those in Equation (5). Further, I″(x, y) denotes a pixel value of a coordinate (x, y) of an image output from the high frequency emphasis filter. Further, α denotes a parameter indicating the degree of emphasis. The filter controller 33 can increase the strength by making a larger by α control signal or making σ in Equation (5) larger.

Further, the processor 22 may use, as the filter that increases the information amount, a filter that emphasizes the contrast or shadow of an image, a filter that emphasizes the edge, a filter that emphasizes the texture, a processing block that adds an simulatively-generated texture, or a processing block that adds a glossiness component.

Further, the filter controller 33 may make the kind and the strength of a filter constant in each image, or may change the kind and the strength of a filter within an image. For example, when the shape of a slice or the shape of a tile at the time of encoding is previously known, the filter controller 33 may change the kind and the strength of a filter in each slice or each tile.

Further, the processor 22 may use not only a filter that filter-processes an image in a space direction (in-screen direction), but also a filter that filter-processes an image in a time direction. As an example, the processor 22 buffers images at times before and after an input image and performs filter processing in the time direction with reference to these images. As an example, the processor 22 motion-compensates images at times before and after an input image with respect to the input image so as to be smoothened in the time direction.

Accordingly, the processor 22 can remove a time-varying noise component. As a result, the processor 22 can reduce the information amount and improve a subjective image quality. When the processor 22 uses a filter in the time direction, the filter controller 33 can change the strength by adjusting the number of images at times before and after an input image, the images being used for smoothing, or the strength of smoothing by a control signal.

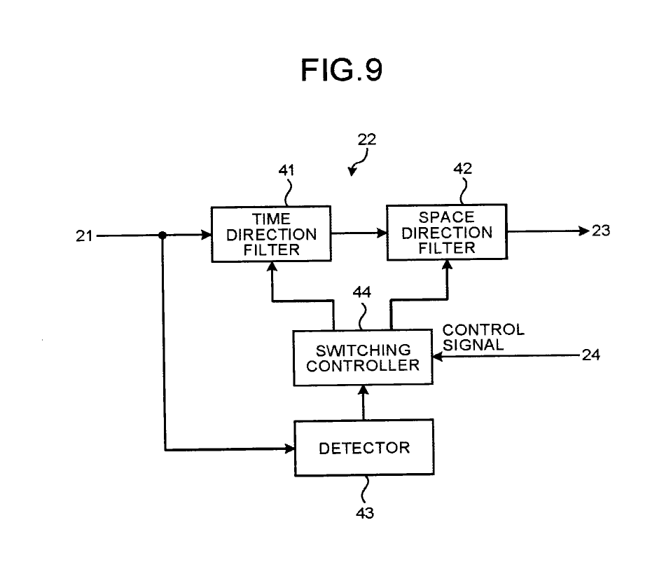

FIG. 9 is a diagram illustrating a first configuration example of the processor 22. As illustrated in FIG. 9, as an example, the processor 22 may perform filter processing using a filter obtained by combining a space direction filter and a time direction filter.

In this case, as an example, the processor 22 includes a time direction filter 41, a space direction filter 42, a detector 43, and a switching controller 44. The time direction filter 41 performs filter processing in the time direction on an image acquired by the acquisition unit 21. The space direction filter 42 performs filter processing in the space direction on the image that has been filter-processed in the time direction by the time direction filter 41. The space direction filter 42 outputs the thus filter-processed image to the encoder 23 in the following stage.

The detector 43 calculates the difference between an input image and an image input one time before the input image. The detector 43 calculates the sum of absolute values of the difference for each small region (block), and determines a block in which the calculated sum is smaller than a predetermined value as a still region. The detector 43 may perform the determination not for each block, but for the unit of pixel.

The switching controller 44 allows the time direction filter 41 to perform the filter processing and the space direction filter 42 to stop the filter processing with respect to the still region within an image. Further, the switching controller 44 allows the time direction filter 41 to stop the filter processing and the space direction filter 42 to perform the filter processing with respect to a region other than the still region within the image. In this case, the switching controller 44 sets the strength of the filter processing following a control signal received from the control unit 24.

Instead of the above, the switching controller 44 may make the strength of the filter processing by the time direction filter 41 stronger than the set strength and make the strength of the filter processing by the space direction filter 42 weaker than the set strength with respect to the still region within an image. Further, the switching controller 44 may make the strength of the filter processing by the time direction filter 41 weaker than the set strength and make the strength of the filter processing by the space direction filter 42 stronger than the set strength with respect to the region other than the still region within an image.

Accordingly, the processor 22 can make the filter in the time direction dominant in the still region in which the blur of the edge and texture caused by the filter processing is likely to be subjectively concerned. The processor 22 can make the filter in the space direction dominant in the region other than the still region in which the blur of the edge and texture is not likely to be subjectively concerned.

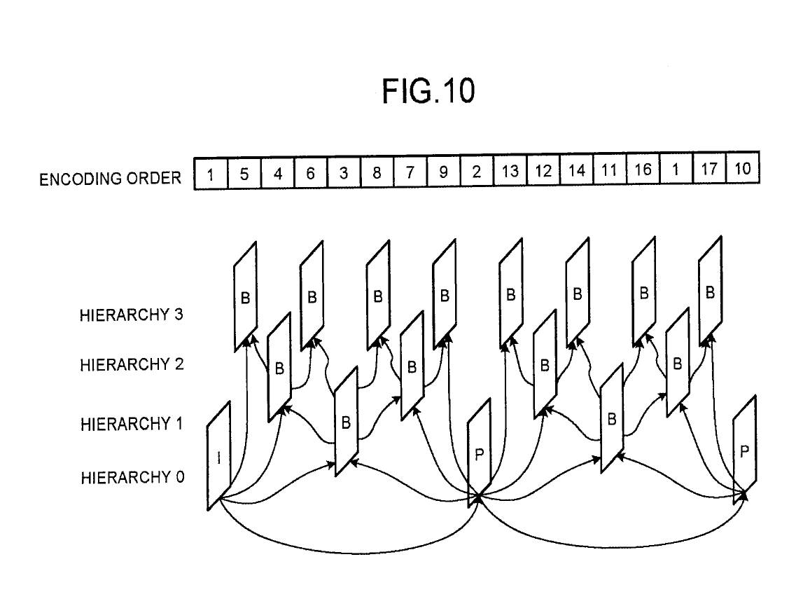

FIG. 10 is a diagram illustrating an example of the prediction structure of encoding. When performing the encoding by a H.264/AVC or H.265/HEVC method, the encoder 23 can have the prediction structure of the encoding as a combination of an intra-frame prediction picture (I picture), a forward-directional inter-frame prediction picture (P picture), and a bidirectional inter-frame prediction picture (B picture) as illustrated in FIG. 10. In FIG. 10, each arrow indicates a prediction direction. Further, in the B pictures, prediction hierarchies are different depending on how many times a B picture is passed through from an I picture and a P picture to perform the prediction. In FIG. 10, a B picture illustrated on the upper side has a deeper prediction hierarchy.

When performing encoding with such a prediction structure, the encoder 23 performs the encoding by changing the order of frames between an I picture and a P picture or frames between a P picture and a subsequent P picture. Therefore, in such a case, the control unit 24 defines frames between an I picture and a P picture or frames between a P picture and a subsequent P picture as one group, and determines a target value of the encoding time for each group.

Further, in this case, the control unit 24 acquires the encoding completion time from the encoder 23 for each group. Further, the control unit 24 acquires the encoding completion target time for each group. Then, the control unit 24 calculates the time difference between the encoding completion time and the encoding completion target time to determine the encoding time target value for each group. In this manner, the control unit. 24 may control the filter processing performed by the processor 22 not for each frame, but for a plurality of frames together. In this case, the target value generator 32 of the control unit 24 calculates the encoding time target value for a plurality of frames combined together.

As described above, the encoding device 10 according to the first embodiment generates, on the basis of the encoding completion target time of a first image included in moving image data and an actual encoding completion time of the first image, a target value of the encoding time spent for encoding a second image that is encoded after the first image. Further, the encoding device 10 according to the first embodiment controls the filter processing for the second image depending on the encoding time target value.

Accordingly, the encoding device 10 according to the first embodiment makes it possible to control, depending on the encoding time of a past image, the information amount of a subsequent image. Therefore, it is possible to reduce variation in the encoding time of each image included in moving image data. As a result, the encoding device 10 according to the first embodiment makes it possible to reliably perform encoding of moving image data in real time. Further, it is possible to encode moving image data at a speed that is equal to the reproduction speed or higher than the reproduction speed.

### Second Embodiment

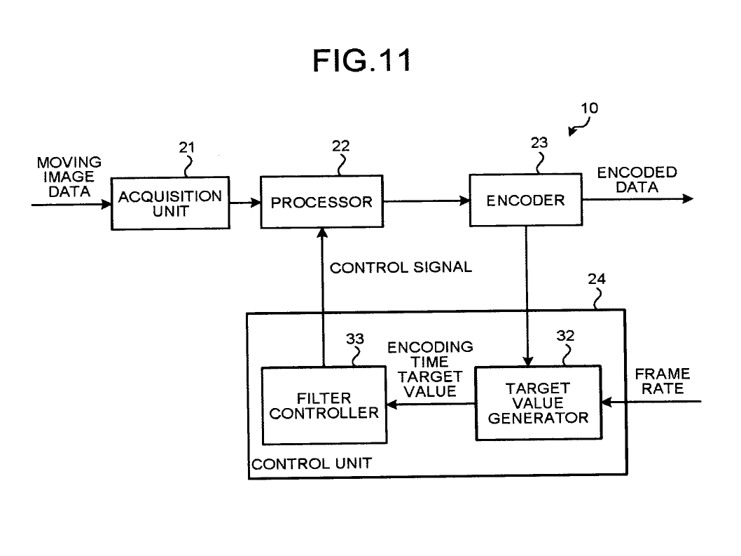

FIG. 11 is a block diagram illustrating an encoding device 10 according to a second embodiment.

A control unit 24 according to the second embodiment includes a target value generator 32 and a filter controller 33. The target value generator 32 acquires a frame rate of moving image(video) data. The target value generator 32 may acquires the frame rate, for example, from an encoder 23 and may also acquire the frame rate from an acquisition unit 21.

The target value generator 32 generates an encoding time target value on the basis of the acquired frame rate. As an example, the target value generator 32 generates a time per one frame calculated from the frame rate as the encoding time target value. For example, when the frame rate is 60 frames/second, the target value generator 32 calculates the encoding time target value as 1/60=approximately 16.7 milliseconds. The filter controller 33 generates a control signal for controlling filter processing performed by a processor 22 on the basis of the encoding time target value calculated by the target value generator 32.

Generally, the frame rate of moving image data is constant. Therefore, the control unit 24, for example, sets the kind and the strength of a filter with respect to the processor 22 at the time of starting the encoding of moving image data, and the setting is fixed thereafter.

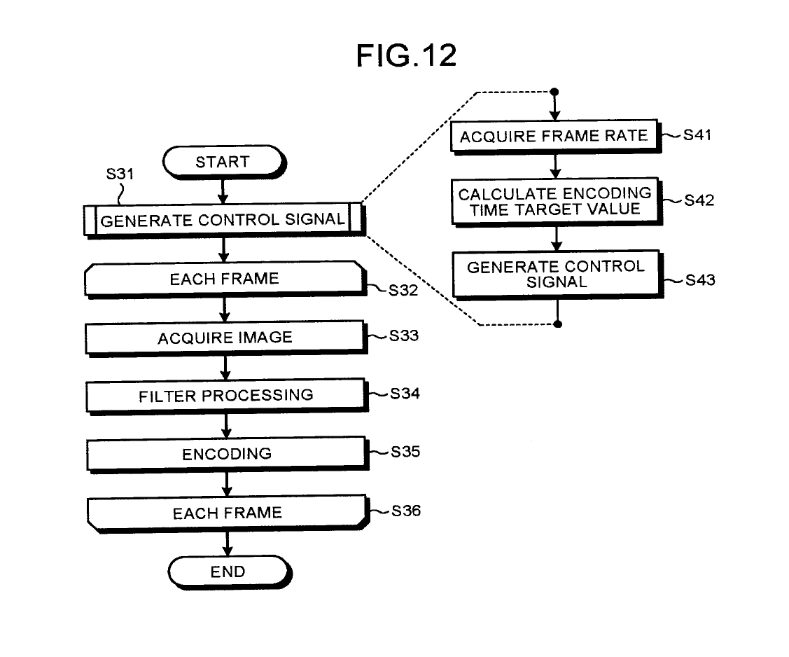

FIG. 12 is a flow chart illustrating the flow of processing performed by the encoding device 10 according to the second embodiment. In the encoding device 10, when the input of moving image data is started, the control unit 24 generates a control signal on the basis of the frame rate of the moving image data in S31. More specifically, in S41, the control unit 24 first acquires the frame rate of the moving image data. Then, in S42, the control unit 24 calculates the encoding time target value on the basis of the frame rate. Then, in S43, the control unit 24 generates the control signal.

When the control signal is generated, the encoding device 10 repeatedly performs processing from S33 to S35 for each frame (or each field) included in the moving image data (loop processing between S32 and S36).

In the loop processing, the acquisition unit 21 first acquires an image in the unit of frame (or in the unit of field) in S33. Then, in S34, the processor 22 performs filter processing on the image acquired by the acquisition unit 21 under the control by the control signal. Then, in S35, the encoder 23 encodes the image filter-processed by the processor 22.

The encoding device 10 repeatedly performs the above processing from S33 to S35 while moving image data is being input. Then, when the input of moving image data is stopped, the encoding device 10 finishes the processing of this flow.

As described above, the encoding device 10 according to the second embodiment generates, on the basis of the frame rate of moving image data, a target value of the encoding time spent for encoding each image included in the moving image data. Further, the encoding device 10 according to the second embodiment controls the filter processing depending on the encoding time target value.

Accordingly, the encoding device 10 according to the second embodiment makes it possible to control the information amount of each of a plurality of images included in moving image data so as to correspond to the frame rate. Therefore, it is possible to reduce variation in the encoding time of each of the images included in the moving image data. As a result, the encoding device 10 according to the second embodiment makes it possible to reliably perform encoding of moving image data in real time. Further, it is possible to encode moving image data at a speed that is equal to the reproduction speed or higher than the reproduction speed.

### Third Embodiment

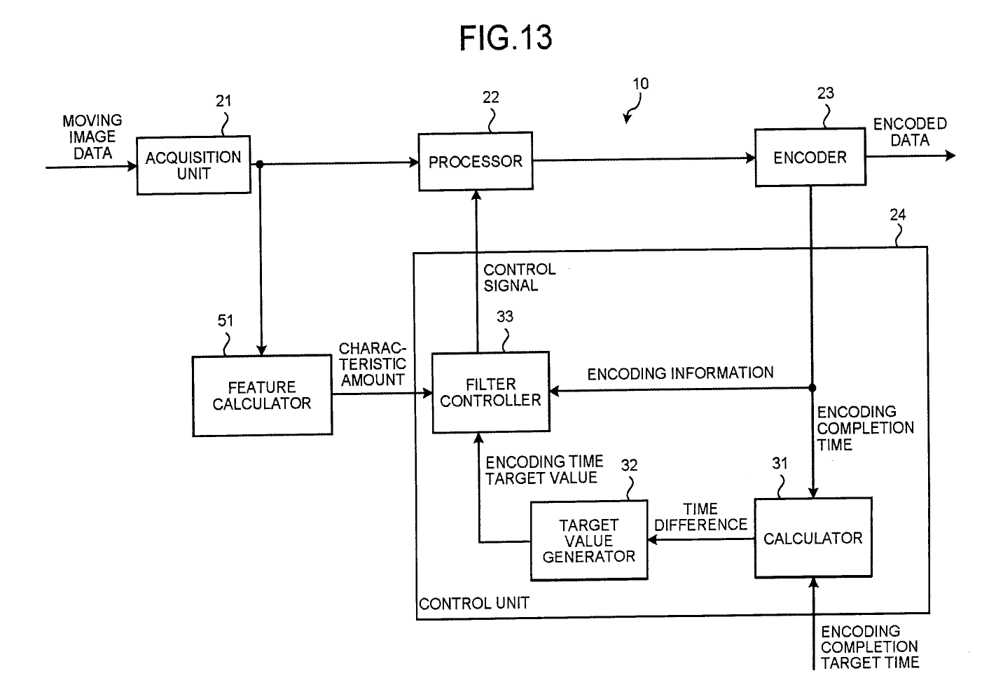

FIG. 13 is a block diagram of an encoding device 10 according to a third embodiment.

The encoding device 10 according to the third embodiment is further provided with a feature calculator 51. The feature calculator 51 calculates a feature relating to the difficulty of encoding in an image included in moving image (video) data. As an example, the feature calculator 51 calculates, as the features, at least one of the activity of an image, the weakness of the adjacent pixel correlation, the motion amount, the reliability of motion estimation, the noise amount, and the scene change occurrence reliability. The difficulty of encoding is estimated to be higher when the activity of an image is larger, the adjacent pixel correlation is weaker, the motion amount is larger, the reliability of motion estimation is lower, the noise amount is larger, and the scene change occurrence reliability is higher.

The activity of an image is represented by an average value f of distribution of pixel values in each block obtained by dividing the image as represented by the following Equation (8).

$$f = {\sum }_{{B}_{i} ∈ B}^{ } ( \frac{1}{{N}_{i}} {\sum }_{( x , y ) ∈ {B}_{i}}^{ } {I ( x , y )}^{2} - {( \frac{1}{{N}_{i}} {\sum }_{( x , y ) ∈ {B}_{i}}^{ } I ( x , y ) )}^{2} ) \qquad ( 8 )$$

In Equation (8), B denotes a set of blocks obtained by dividing an image. Further, Nᵢ denotes the number of pixels belonging to one block selected from B.

The reliability of motion estimation is represented by the difference between an input image and an image at a time before the input image when the two images are motion-compensated using a calculated motion vector between the two images. The scene change occurrence reliability is represented by the probability of the occurrence of scene change.

The feature calculator 51 may calculate any one kind of feature, and may also calculate a value obtained by combining a plurality of kinds of features. The feature calculator 51 can accurately estimate the difficulty of encoding by calculating a value obtained by combining a plurality of features.

Further, a control unit 24 according to the third embodiment acquires encoding information from an encoder 23 together with an encoding completion time. The control unit 24 acquires, as the encoding information, for example, the mode of encoding, information about a deblocking filter, information about the generated code amount, information about a motion vector, information about a loop filter introduced into H.265/HEVC, or information about a quantization matrix.

The mode of encoding is information that indicates whether a frame is encoded by intra-frame prediction, forward-directional inter-frame prediction, or bidirectional inter-frame prediction. In other words, the mode of encoding is information that indicates whether a frame is an I picture, P picture or B picture. Further, when a frame is a B picture, the mode of encoding may include information about the depth of the prediction hierarchy.

A filter controller 33 according to the third embodiment controls filter processing performed by a processor 22 depending on the feature calculated by the feature calculator 51 and encoding information acquired from the encoder 23 together with an encoding time target value generated by a target value generator 32.

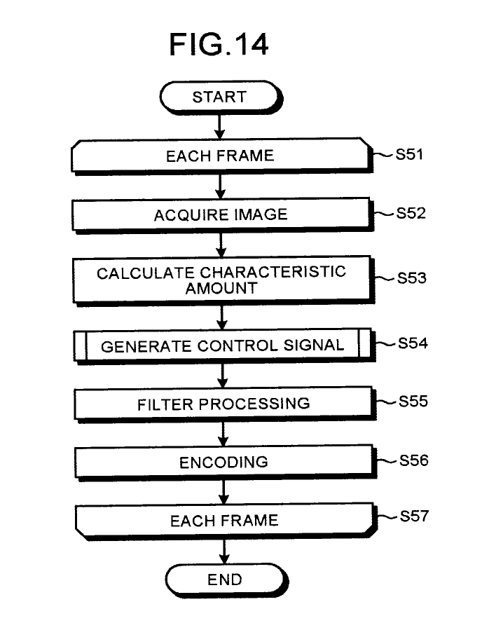

FIG. 14 is a flow chart illustrating the flow of processing performed by the encoding device 10 according to the third embodiment. When the input of moving image data is started, the encoding device 10 repeatedly performs processing from S52 to S56 for each frame (or each field) included in the moving image data (loop processing between S51 and S57).

In the loop processing, the acquisition unit 21 first acquires an image (second image) in the unit of frame (or in the unit of field) in S52. Then, in S53, the feature calculator 51 calculates the feature of the image (second image) acquired by an acquisition unit 21.

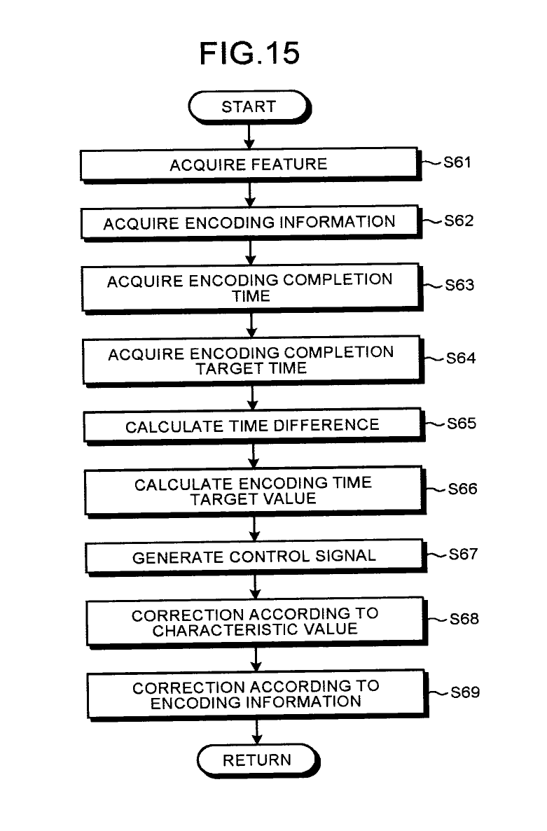

Then, in S54, the control unit 24 generates a control signal for controlling the information reduction amount or the information increasing amount. A procedure for generating the control signal will be described below with reference to the flow of FIG. 15.

Then, in S55, the processor 22 performs filter processing on the image (second image) acquired by the acquisition unit 21 under the control by the control signal. Then, in S56, the encoder 23 encodes the image (second image) filter-processed by the processor 22.

The encoding device 10 repeatedly performs the processing from S52 to S56 while moving image data is being input. Then, when the input of moving image data is stopped, the encoding device 10 finishes the processing of this flow.

FIG. 15 is a flow chart illustrating the processing of S54 of FIG. 14. In S54, the control unit 24 performs processing from S61 to 869 of FIG. 15.

First, in S61, the control unit 24 acquires the feature calculated by the feature calculator 51. Then, in S62, the control unit 24 acquires encoding information from the encoder 23.

Then, in S63, the control unit 24 acquires the encoding completion time of an image (first image) encoded in the past. Then, in S64, the control unit 24 acquires the encoding completion target time of the image (first image) encoded in the past. Then, in S65, the control unit 24 calculates the difference between the encoding completion time and the target time of the image (first image) encoded in the past.

Then, in S66, the control unit 24 calculates a target value of the encoding time spent for encoding an image (second image) acquired by the acquisition unit 21 on the basis of the time calculated in S65. Then, in S67, the control unit 24 generates a control signal for controlling the filter processing performed by the processor 22 on the basis of the encoding time target value.

Then, in S68, the control unit 24 corrects the generated control signal depending on the feature calculated by the feature calculator 51. The control unit 24 corrects the control signal so as to make the information reduction amount of the processor 22 larger or the information increasing amount smaller as the difficulty of encoding is indicated to be higher by the feature calculated by the feature calculator 51.

Then, in S69, the control unit 24 further corrects the control signal that has been corrected by the feature depending on the encoding information.

For example, the control unit 24 corrects the control signal using information about the mode of encoding. More specifically, when a current image is encoded as an I picture, the control unit 24 corrects the control signal so that the strength is increased when a filter that reduces the information amount is designated and the strength is reduced when a filter that increases the information amount is designated. For example, the encoding time of an I picture is longer than the encoding time of a P picture or a B picture in many cases. Therefore, by performing such correction, the control unit 24 can further equalize the encoding time of the I picture, the P picture, and the B picture.

Further, when a current image is encoded as a B picture having a deep prediction hierarchy, the control unit 24 corrects the control signal so that the strength is reduced when the filter that reduces the information amount is designated and the strength is increased when the filter that increases the information amount is designated. For example, among B pictures, the encoding time is reduced in a B picture having a deep prediction hierarchy in many cases. Therefore, by performing such correction, the control unit 24 can equalize the encoding time between a B picture having a deep prediction hierarchy and a B picture having a shallow prediction hierarchy.

Further, the control unit 24 may correct the control signal using information about a deblocking filter. More specifically, in a scene in which a deblocking filter is likely to be strongly applied, the information amount of an image is likely to be reduced at the time of encoding. Therefore, the control unit 24 corrects the control signal so as to reduce the effect of the reduction of the information amount by the filter.

Further, the control unit 24 may correct the control signal using information about the generated code amount. More specifically, the control unit 24 corrects the control signal so as to make the information reduction amount by a filter larger when the generated code amount is larger than a target code amount and make the information reduction amount by the filter smaller when the generated code amount is smaller than the target code amount.

Further, the control unit 24 may correct the control signal using information about a motion vector. More specifically, when the motion vector is large, the correlation of the motion vector with an adjacent block is weak, and the information amount of an image is therefore likely to be increased at the time of encoding. Therefore, the control unit 24 corrects the control signal so as to make the information reduction amount by the filter larger.

Further, the control unit 24 may correct the control signal, for example, using information about a loop filter introduced into H.265/HEVC. For example, in H.265/HEVC, a loop filter that corrects an encoded image by using an offset corresponding to the edge or signal band of the image as a pixel adaptive offset is employed. The control unit 24 corrects the control signal so as to increase or reduce the information amount by the filter depending on these offset values.

Then, when the processing of S69 is finished, the control unit 24 advances the processing to S55 of FIG. 14.

As described above, the encoding device 10 according to the third embodiment corrects the filter processing on the basis of the feature of an image and encoding information. Accordingly, the encoding device 10 according to the third embodiment controls, on the basis of the encoding time of a past image, the information amount of a subsequent image. Further, the encoding device 10 according to the third embodiment controls the information amount of an image on the basis of the feature and encoding information of the image. Therefore, it is possible to further reduce variation in the encoding time in each image included in moving image data.

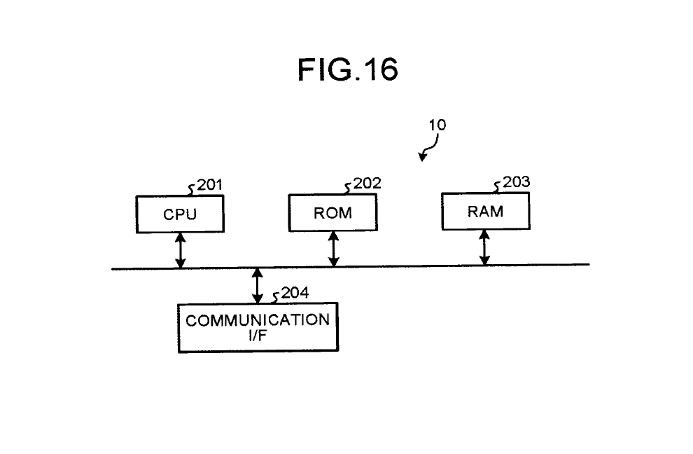

FIG. 16 is a diagram illustrating an example of the hardware of the encoding device 10 according to the first to third embodiments. The encoding device 10 according to the first to third embodiments is provided with a control device such as a central processing unit (CPU) 201, a read only memory (ROM) 202, and a random access memory (RAM) 203, a communication I/F 204 which is connected to a network to perform communication, and a bus which connects respective parts.

A program executed in the encoding device 10 according to the embodiments is provided by being previously incorporated in the ROM 202 or the like.

A program executed in the encoding device 10 according to the embodiments may be recorded in a computer-readable storage medium such as a compact disk read only memory (CD-ROM), a flexible disk (FD), a compact disk recordable (CD-R), and a digital versatile disk (DVD), as a file in an installable format or an executable format and provided as a computer program product.

Further, a program executed in the encoding device 10 according to the embodiments may be stored on a computer connected to a network such as the Internet and provided by being downloaded through the network. Further, a program executed in the encoding device 10 according to the embodiments may be provided or distributed through a network such as the Internet.

A program executed in the encoding device 10 according to the embodiments includes an acquisition module, a processing module, an encoding module, and a control module, and can allow a computer to function as the respective units (the acquisition unit 21, the processor 22, the encoder 23, and the control unit 24) of the encoding device 10 described above. In the computer, the CPU 201 can read the program from a computer-readable storage medium on a main storage device and execute the program. Some or all of the acquisition unit 21, the processor 22, the encoder 23, and the control unit 24 may be configured or may be implemented by hardware such as a circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An encoding device comprising:
a processor; and
a memory that stores processor-executable instructions that, when executed by the processor, cause the processor to:
apply a filter to first and second images included in video data;
encode the first and second images to which the filter has been applied and generate encoded data;
generate, on the basis of an encoding completion target time of the first image, a target value of an encoding time spent for encoding the second image to he encoded after the first image; and
control the applying of the filter for the second image depending on the target value of the encoding time.

2. The device according to claim 1, wherein the processor further generates the target value of the encoding time spent for encoding the second image on the basis of a time at which encoding of the first image is completed and the encoding completion target time of the first image.

3. The device according to claim 1, wherein the processor further calculates the encoding completion target time of the first image on the basis of a frame rate of the video data.

4. The device according to claim 1, wherein the processor further applies the filter for reducing an information amount on images included in the video data.

5. The device according to claim 4, wherein the processor further controls the applying of the filter so that the smaller the target value of the encoding time, the larger an information reduction amount.

6. The device according to claim 5, wherein the processor further controls the applying of the filter so that the larger the target value of the encoding time, the larger an information increasing amount.

7. The device according to claim 4, wherein the processor further applies as the filter a low pass filter to the images included in the video data.

8. The device according to claim 1, wherein the processor further applies the filter for increasing an information amount to the images included in the video data.

9. The device according to claim 1, wherein the processor further performs:
applying a filter obtained by combining a space direction filter and a time direction filter to the images included in the video data;
detecting a still region of an image included in the video data; and
making an effect by the time direction filter stronger than an effect by the space direction filter with respect to the still region and making the effect by the space direction filter stronger than the effect by the time direction filter with respect to a region other than the still region.

10. The device according to claim 1, wherein the processor further controls the applying of the filter depending on at least one of information about whether a frame is an intra-frame prediction picture, a forward-directional inter-frame prediction picture or a bidirectional inter-frame prediction picture, information about a depth of prediction for the bidirectional inter-frame prediction picture, information about a deblocking filter, information about a loop filter, information about a generated code amount, and information about a quantization matrix, and the target value of the encoding time.

11. The device according to claim 1, wherein the processor further applies as the filter a noise removal filter to the images included in the video data.

12. The device according to claim 11, wherein the processor uses, as the noise removal filter, at least one of a bilateral filter, a median filter, and processing employing a non-local-means method.

13. The device according to claim 1, wherein the processor further performs:
calculating a feature of an image included in the video data; and
controlling the applying of the filter depending on the feature and the target value of the encoding time.

14. The device according to claim 13, wherein the processor further calculates, as the feature, at least one of an activity of an image, a weakness of adjacent pixel correlation, a motion amount, a reliability of motion estimation, a noise amount, and a reliability of scene change occurrence.

15. The device according to claim 13, wherein the processor further controls the applying of the filter so that an information reduction amount of filtering is increased when a value of the feature is larger than a predetermined value.

16. An encoding method comprising:
applying a filter to first and second images included in video data;
encoding the first and second images to which the filter has been applied and generating encoded data;
generating, on the basis of an encoding completion target time of the first image, a target value of an encoding time spent for encoding the second image to be encoded after the first image; and
controlling the applying of the filter for the second image depending on the target value of the encoding time.

17. An encoding device comprising:
a circuitry that applies a filter to first and second images included in video data;
a circuitry that encodes the first and second images to which the filter has been applied and that generates encoded data;
a circuitry that generates, on the basis of an encoding completion target time of the first image, a target value of an encoding time spent for encoding the second image to be encoded after the first image; and
a circuitry that controls the applying of the filter for the second image depending on the target value of the encoding time.
